(19) United States
(12) Patent Application Publication
(10) Pub. No.: US 2014/0209441 A1
(43) Pub. Date: Jul. 31, 2014

(54) ROTARY SWITCH HAVING DURABLE INTERNAL CONTACTS

(71) Applicants: HONG FU JIN PRECISION INDUSTRY (ShenZhen) CO., LTD., (US); HON HAI PRECISION INDUSTRY CO., LTD., New Taipei (TW)

(72) Inventor: Xin YANG, Shenzhen (CN)

(73) Assignees: HON HAI PRECISION INDUSTRY CO., LTD., New Taipei (TW); HONG FU JIN PRECISION INDUSTRY(ShenZhen) CO., LTD., Shenzhen (CN)

(21) Appl. No.: 13/851,922

(22) Filed: Mar. 27, 2013

(30) Foreign Application Priority Data
Jan. 30, 2013 (CN) 201310035446.3

(51) Int. Cl. H01H 67/02

(52) U.S. Cl. CPC H01H 67/02
USPC 200/179

(57) ABSTRACT

A rotary switch includes a base, a rotary mechanism, and a manipulation member. The base includes a shell and a circuit board. An annular supporting portion is arranged in the shell. A number of protrusions are formed on a top of the supporting portion. An indentation is defined between every two neighboring protrusions. The circuit board includes a number of contact pieces corresponding to the indentations. The rotary mechanism is installed in the shell and includes a rotary pole, a connecting member slidably connected to a top of the rotary pole, an abutting pole telescopically mounted to an end of the rotary pole, and a resilient member mounted between the rotary pole and the connecting member. The rotary pole includes a trigger to make connections with the contact pieces. The manipulation member is rotatably mounted to the shell and fixed to the connecting member.

### BACKGROUND

1. Technical Field

The present disclosure relates to a rotary switch.

2. Description of Related Art

A rotary switch generally includes a base having a plurality of contact pieces arrayed in a shape of arc and a rotary mechanism rotatably installed to the base. The rotary mechanism includes an arm to be selectively coupled to one of the contact pieces by rotating the rotary mechanism. The arm moves over the contacts in rotation of the rotary mechanism. Therefore, the arm and the contact pieces tend to be quickly worn out because of the friction, resulting in a shortening of the service life of the rotary switch.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIGS. 1 and 2 are exploded, isometric views of an exemplary embodiment of a rotary switch, from different perspectives.

FIG. 3 is an assembled, isometric view of the rotary switch of FIG. 1.

FIG. 4 is a cutaway view of the rotary switch of FIG. 3.

FIG. 5 is similar to FIG. 3, but showing a different state.

FIG. 6 is a cutaway view of the device in FIG. 5.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

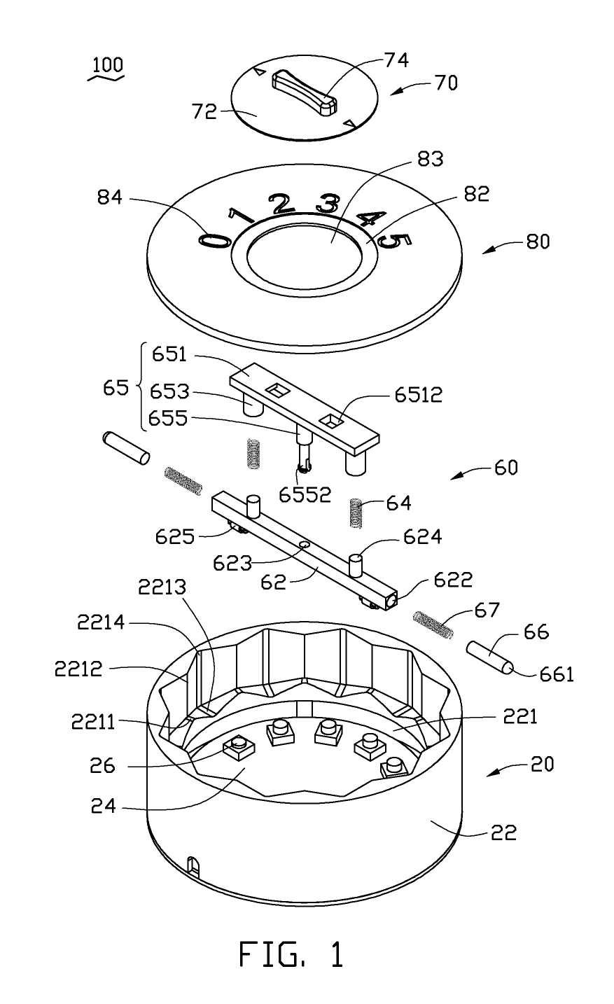

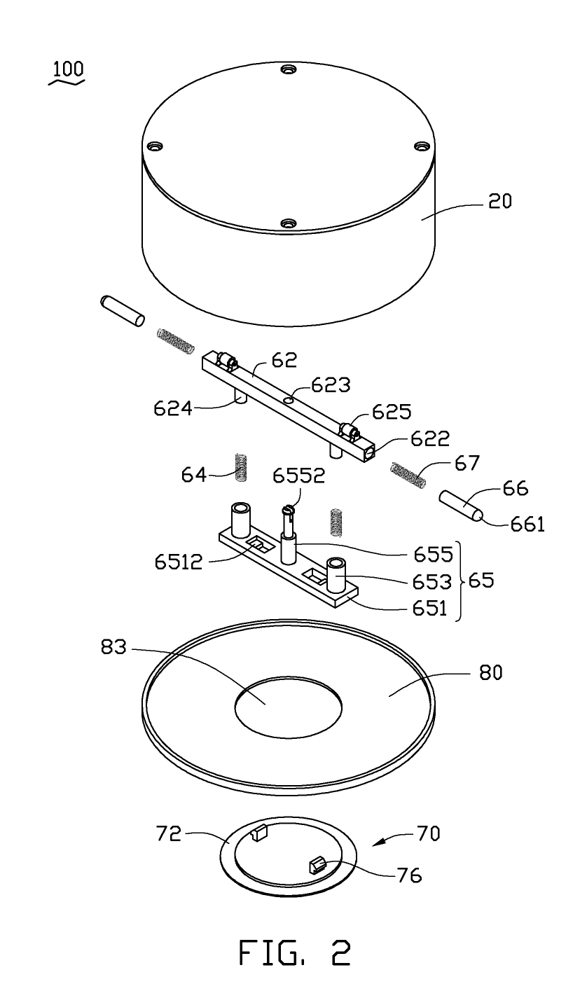

Referring to FIGS. 1 and 2, an exemplary embodiment of a rotary switch 100 includes a base 20, a rotary mechanism 60, a manipulation member 70, and a cover 80.

The base 20 includes a cylindrical shell 22 and a circuit board 24 received in the shell 22. An annular supporting portion 221 protrudes from an inner side of an annular wall of the shell 22. A plurality of evenly spaced wedge-shaped protrusions 2211 is formed on a top of the supporting portion 221. An indentation 2213 is defined between every two neighboring protrusions 2211. A plurality of evenly spaced wedge-shaped protrusions 2212 is formed on the inner side of the annular wall of the shell 22, above the supporting portion 221. An indentation 2214 is defined between every two neighboring protrusions 2212, aligning with one of the indentations 2213. A plurality of contact pieces 26 is arranged on the circuit board 24, evenly spaced and arrayed in a shape of arc which would form a circle concentric with the supporting portion 221. Each of the contact pieces 26 aligns with one of the indentations 2213 of the supporting portion 221.

The rotary mechanism 60 includes a rotary pole 62, two abutting poles 66, a connecting member 65, two first resilient members 64, and two second resilient members 67. Two receiving holes 622 are axially defined in opposite ends of the rotary pole 62. A through hole 623 is defined in a center of the rotary pole 62, with an axis of the through hole 623 perpendicular to a lengthwise direction of the rotary pole 62. Two mounting columns 624 extend up from the rotary pole 62 and are symmetrically arranged at opposite sides of the through hole 623. Two triggers 625 are rotatably mounted to the rotary pole 62 adjacent to the opposite ends of the rotary pole 62. Each of the abutting poles 66 forms a hemispherical abutting end 661. The connecting member 65 includes a rectangular connecting board 651, a sliding pole 655 extending down from a center of the connecting board 651, and two cylindrical sleeves 653 extending down from the connecting board 651 and symmetrically arranged at opposite sides of the sliding pole 655. The connecting board 651 defines two retaining holes 6512, arranged between the sliding pole 655 and the two sleeves 653. Two spaced stopping tabs 6552 are formed at the bottom end of the sliding pole 655. In one embodiment, the first and second resilient members 64 and 67 are coil springs.

The manipulation member 70 for the use of a user includes a round rotating plate 72, a bar-shaped handle 74 protruding from a top of the rotating plate 72, and two hooks 76 protruding from a bottom of the rotating plate 72.

The cover 80 is round, and defines a round through hole 83 in a center of the cover 80 and an annular recess 82 concentric with, and surrounding, the through hole 83. A plurality of evenly spaced marks 84 is shown on the top of the cover 80 and arrayed in a shape of arc concentric with, and surrounding, the recess 82.

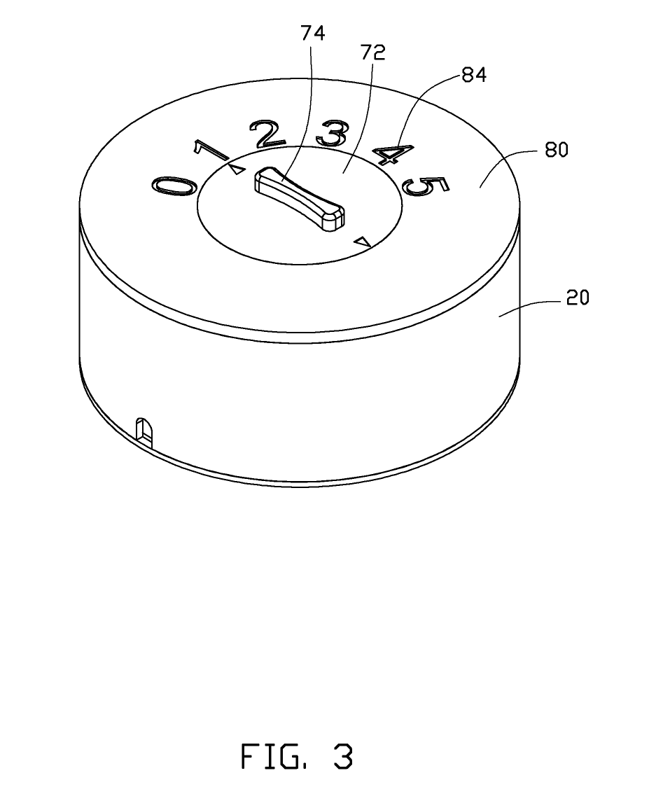

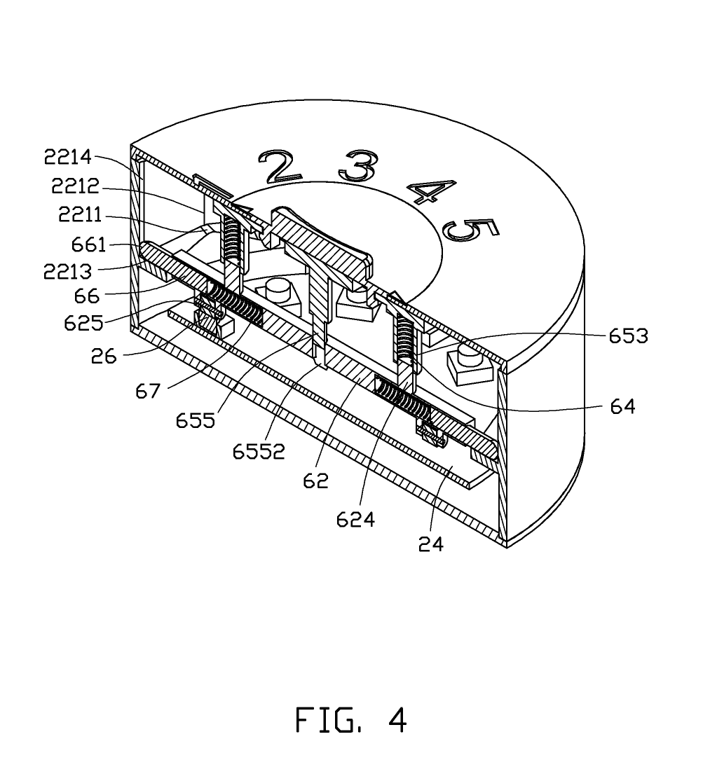

Referring to FIGS. 3 and 4, in assembly, the first resilient members 64 are received in the sleeves 653 of the connecting member 65. The sleeves 653 are installed on the mounting columns 624 of the rotary pole 62. Opposite ends of the first resilient members 64 abut against the mounting columns 624 and the bottom of the connecting board 651 in the sleeves 653. The sliding pole 6552 of the connecting member 65 slidably extends through the through hole 623 of the rotary pole 62. The stopping tabs 6552 abut against the bottom of the rotary pole 62, to prevent the connecting member 65 from disengaging with the rotary pole 62.

A bottom of the cover 80 abuts against the top of the connecting board 651, with the retaining holes 6512 exposed through the through hole 83 of the cover 80. The rotating plate 72 is engaged in the recess 82 of the cover 80, with the hooks 76 extending through the through holes 83 of the cover 80 and fixed in the retaining holes 6512, to fix the connecting member 65 and the manipulation member 70 to the cover 80.

The second resilient members 67 are received in the receiving holes 622 of the rotary pole 62. The abutting poles 66 slidably extend into the receiving holes 622. Opposite ends of the second resilient members 67 abut against ends of the abutting poles 66 opposite to the abutting ends 661 and blind ends of the receiving holes 622.

The cover 80 is covered and fixed to the top of the shell 22, with the rotary mechanism 60 accommodated in the shell 22 and the marks 84 aligning with the contact pieces 26 of the circuit board 24. The abutting poles 66 are supported on the supporting portion 221. The second resilient members 67 constantly urge the abutting ends 661 of the abutting poles 66 press against the inner side of the annular wall of the shell 22. The triggers 625 align with the arc in which the contact pieces 26 are arrayed. The first resilient members 64 push the rotary pole 62 downwards to engage the abutting poles 66 in the indentations 2213 of the supporting portion 221, thereby the triggers 625 contact and trigger connections with the contact pieces 26. At the same time, the abutting ends 661 of the abutting poles 66 are received in the indentations 2214.

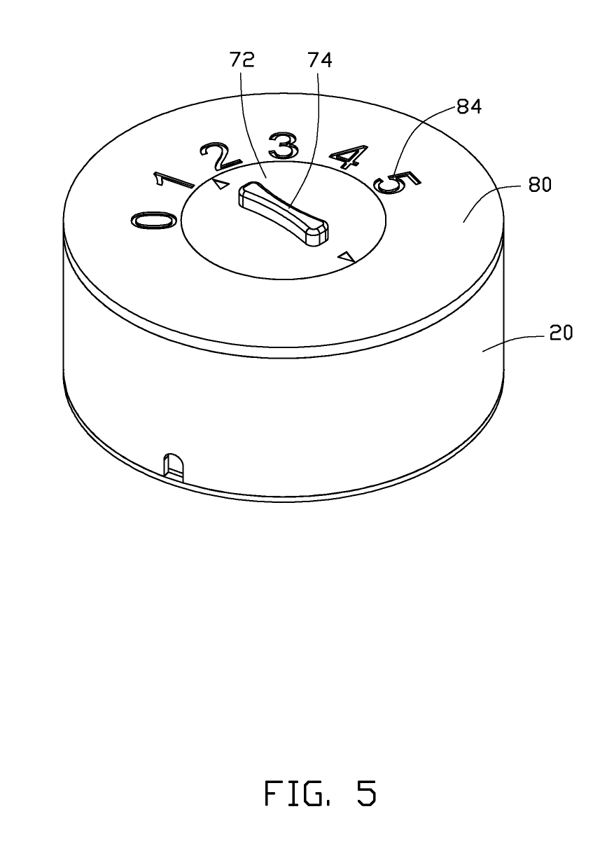

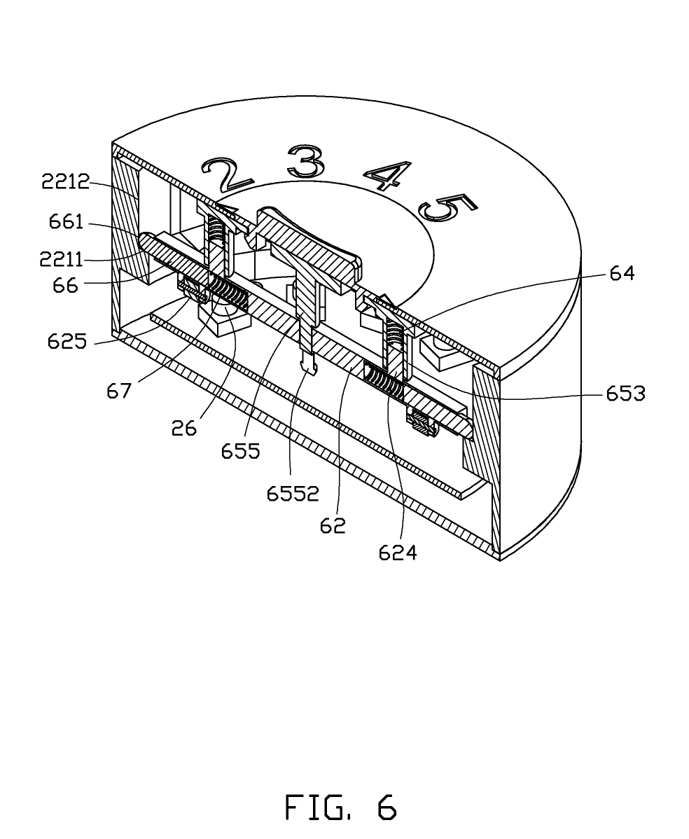

Referring to FIGS. 5 and 6, in use, the handle 74 is rotated. The abutting poles 66 slide out of the indentations 2213 towards the neighboring protrusions 2211 to lift the rotary pole 62, thereby disengaging the triggers 625 from the contacting pieces 26 and deforming the first resilient members 64. At the same time, the abutting ends 661 of abutting poles 66 slide out of the indentations 2214 towards the neighboring protrusions 2212 to deform the second resilient members 67. When the abutting poles 66 pass over the protrusions 2211, the first resilient members 64 restore to drive the abutting poles 66 downwards, making the abutting poles 66 engage in next indentations 2213 of the supporting portion 221 and causing the triggers 625 to contact and trigger connections with the contact pieces 26 which are aligned with the next indentations 2213. At the same time, the second resilient members 67 restore to bias the abutting poles 66 away from each other to make the abutting poles 66 slide into next indentations 2214 on the annular wall of the shell 22.

It is to be understood, however, that even though numerous characteristics and advantages of the embodiments have been set forth in the foregoing description, together with details of the structure and function of the embodiments, the present disclosure is illustrative only, and changes may be made in details, especially in the matters of shape, size, and arrangement of parts within the principles of the embodiments to the full extent indicated by the broad general meaning of the terms in which the appended claims are expressed.

What is claimed is:

1. A rotary switch, comprising:
a base comprising a shell and a circuit board received in the shell, the shell comprising an annular supporting portion inside the shell and above the circuit board, the supporting portion comprising a plurality of spaced first protrusions protruding on a top of the supporting portion, and defining a plurality of first indentations, each first indentation arranged in two neighboring first protrusions of the supporting portion, the circuit board comprising a plurality of contact pieces located on a top side of the circuit board, and arrayed in a shape of arc concentric with the supporting portion, each of the contact pieces aligning with one of the first indentations of the supporting portion;
a rotary mechanism accommodated in the shell and comprising a rotary pole arranged above the supporting portion, a connecting member arranged above the rotary pole and slidably connected to the rotary pole, an abutting pole extending from an end of the rotary pole, and a first resilient member connected between the connecting member and the rotary pole to bias the rotary pole towards the circuit board, the rotary pole comprising a trigger attached to a bottom of the rotary pole, and aligning with the arc-arrayed contact pieces; and
a manipulation member mounted to a top of the shell and fixed to the connecting member.

2. The rotary switch of claim 1, wherein the shell is cylindrical, and comprises a plurality of spaced second protrusions protruding on an inner side of an annular wall of the shell above the supporting portion, and defines a plurality of second indentations, each second indentation is arranged in two neighboring second protrusions; the abutting pole is telescopically connected to the rotary pole, the rotary mechanism further comprises a second resilient member connected between the rotary pole and the abutting pole to bias the abutting pole to abut against the inner side of the annular wall of the shell.

3. The rotary switch of claim 2, wherein the rotary pole defines a through hole in a center of the rotary pole, and comprises two mounting columns extending up from the rotary pole and symmetrically arranged at opposite sides of the through hole; the connecting member comprises a connecting board, a sliding pole extending down from the connecting board and slidably extending through the through hole of the rotary pole, and two sleeves extending down from the connecting board and slidably sleeved on the mounting columns.

4. The rotary switch of claim 3, wherein the second resilient member is received in one of the sleeves and abuts against the corresponding mounting column.

5. The rotary switch of claim 1, further comprising a cover fixed to a top of the shell, wherein the manipulation member is rotatably mounted to a top of the cover and fixedly connected to the connecting member.

6. The rotary switch of claim 5, wherein the cover defines a through hole and an annular recess concentric with and surrounding the through hole of the cover, the manipulation member comprises a rotating plate engaging in the recess of the cover.

7. The rotary switch of claim 6, wherein the manipulation member further comprises a handle protruding on a top of the rotating plate.

8. The rotary switch of claim 7, wherein the connecting member defines a retaining hole, the manipulation member further comprises a hook protruding on a bottom of the rotating plate and extending through the through hole of the cover to be fixed in the retaining hole of the connecting member.
